(19) United States
(12) Patent Application Publication
(10) Pub. No.: US 2018/0330366 A1
(43) Pub. Date: Nov. 15, 2018

(54) A TRANSACTION SYSTEM AND METHOD OF OPERATING SAME

(71) Applicant: Cloudone Technology Proprietary Limited, Cape Town (ZA)

(72) Inventors: Daniel Jacobus Buys, Cape Town (ZA); Vishen Pillay, Durban (ZA)

(73) Assignee: Cloudone Technology Proprietary Limited, Cape Town (ZA)

(21) Appl. No.: 15/774,571

(22) PCT Filed: Nov. 9, 2016
(86) PCT No.: PCT/IB2016/056740

§ 371 Date: May 8, 2018

(30) Foreign Application Priority Data
Nov. 9, 2015 (ZA) 2015/08237
Jan. 28, 2016 (ZA) 2016/00617

(51) Int. Cl. G06Q 20/38; G06Q 20/40; G06Q 20/36; G06Q 30/06; G06F 17/30

(52) U.S. Cl. CPC G06Q 20/385; G06Q 20/401; G06F 17/30702; G06Q 20/36; G06Q 30/06; G06Q 20/382

(57) ABSTRACT

This invention relates to a financial transaction system and to a method of operating the same. The system comprises a database configured to store data in a secure fashion; and processors comprising a purchaser receiver module, a security code generating module, a code transmission module, and a merchant receiver module. The purchaser receiver module is configured to receive transaction data associated with a transaction. The security code generating module is configured to generate a timed transaction linked security code in response to receiving transaction data. The code transmission module is operable to transmit the security code for use by a purchaser. The merchant receiver module is configured to receive a security code transmitted by a merchant at an endpoint device, wherein the merchant transmitted code is received from a purchaser in respect of a transaction; and determine whether the security code received is valid so as to process the transaction.

### CROSS-REFERENCE TO RELATED APPLICATION

This application is a continuation of International Application No. PCT/IB2016/056740, filed Nov. 9, 2016, which claims the benefit of South African Application No. 2015/08237, filed Nov. 9, 2015 and South African Application No. 2016/00617, filed Jan. 28, 2016.

### FIELD OF INVENTION

THIS INVENTION relates generally to commercial transaction systems and methods of operating same, and particularly to secure commercial transactions.

### BACKGROUND OF INVENTION

Many financial transactions often require purchasers of goods and/or services to make a payment or to authorize an amount to a merchant or seller of said goods and/or services in respect of a particular transaction for the purchase of said goods and/or services, or a deposit in respect thereof, whilst the purchaser is communicating verbally with said merchant. The transaction needs to take place based on mutually agreed and recorded terms and conditions. For, example during a telephonic booking for a service offered by a merchant, the merchant may require a deposit or authorization of a particular amount of funds in order to accept or confirm said booking.

One way in which purchasers may provide a required deposit is to utilize online electronic banking facilities whereby the user would have to connect to the internet, log into their online banking profile, make payment, and then provide confirmation of such payment to the merchant before the latter proceeds with the booking. A difficulty with this approach is that it involves a fair amount of time for a user to proceed with a transaction in this fashion, which is often impractical during a verbal transaction. In addition, if the purchaser does not readily have the merchant's banking details at hand, this method of transacting becomes inconvenient as these details will have to be obtained, and correctly entered into the required fields by the purchaser on their electronic banking platform. It thus follows that proceeding in this fashion, would create a great degree of difficulty and would waste the time and resources of both the purchaser and merchant if the merchant had to maintain verbal contact with the purchaser whilst the purchaser had to process a transaction in this fashion. In addition, by manually entering a merchant's banking details into the associated fields in an online transaction whilst conversing with a merchant, the risk for error in capturing the detail correctly is higher.

Another way in which a required deposit or authorization may be processed is via an online platform which a purchaser is re-directed to, for example, via a merchant's website, wherein the purchaser inserts login credentials and facilitates the processing of the transaction with the merchant via the online platform. The difficulty with this example methodology is that it does not lend itself well to certain types of interactive transacting between the purchaser and the merchant and is more suited to online transactions.

Yet another way in which a required deposit or authorization may be processed, in the case where a transaction comprises a interactive verbal element between a purchaser and a merchant, would be for the purchaser to provide their bank card details to the merchant verbally in order for the merchant to drive the processing of the payment on the merchant's end. In other words, on receipt of the bank card details, the merchant utilizes the same to take a deposit or authorize an amount for the booking on the bank card. One particular difficulty associated with this approach is that the safety of a purchaser's bank card details is not guaranteed and thus any subsequent unauthorized use of the purchaser's bank card details in a fraudulent manner will only be determined after a fraudulent transaction occurs.

It is thus an object of the present invention to address the aforementioned problems or difficulties and provide a means to facilitate an alternate and/or more secure electron transaction.

### SUMMARY OF THE INVENTION

According to a first aspect of the invention, there is provided a financial transaction system comprising:

a database configured to store data in a secure fashion; and

one or more processors comprising:
a purchaser receiver module configured to:
   receive transaction data associated with a transaction for one or both of payment and authorization of a financial amount from a purchaser to a merchant, wherein received transaction data comprises information selected from a group comprising identifier information associated with the purchaser, a financial amount associated with the transaction, financial currency associated with the transaction, and a transaction identifier identifying the transaction;
a security code generating module configured to generate a timed security code, valid for a pre-determined period of time, in response to receiving transaction data, wherein the generated timed security code is linked to an associated transaction;
a code transmission module operable to transmit a generated security code for use by a purchaser wherein, in use, the security code is presented to a merchant by the purchaser in order to process a transaction associated with the security code; and
a merchant receiver module configured to:
   receive a security code transmitted by a merchant at a merchant endpoint device, wherein the security code transmitted by the merchant is received thereby from a purchaser in respect of a transaction; and
   determine whether the security code received is valid, or not, so as to allow or deny the associated transaction or facilitate processing the transaction.

The security code received by the merchant receiver module may be a human-readable code presented or provided verbally, particularly vocally/orally, by the purchaser and is input to the merchant endpoint device. In this regard, it will be noted that the security code may essentially be read out aloud orally/vocally by the purchaser to the merchant. The merchant may typically hear the code audibly and inputs the same to the merchant endpoint device. However, it will be appreciated that in one example embodiment, the merchant endpoint device may input the code presented verbally by the purchaser by recording the audible code read out by the purchaser. The recorded code, for example, in the form of a suitable sound file containing the security code read out by the purchaser may be received by the merchant receiver module and processed to determine if the security code read out matches the code transmitted to the purchaser as will be described below.

The secure database may be in the form of a Payment Card Industry Data Security Standard (PCI DSS) compliant database.

The security code may be selected from a group comprising a numeric code, an alpha-numeric code, a character-based code, and an image which may be perceivable by a human purchaser.

The database may be configured to store data comprising a plurality of user profiles associated with one or both of purchasers and merchants, wherein the user profiles stores account data associated with one or more external financial accounts associated with the purchasers and users as well as personal data associated therewith.

The purchaser receiver module may be configured to: receive transaction data from a purchaser having a user profile stored in the database, wherein the received transaction data comprises information indicative of the financial account from which the purchaser desires to one or both of pay and authorize the financial amount; and associate the received transaction data with the user profile of the associated purchaser in the database.

The security code generating module may be configured to: generate a timed security code in response to receiving transaction data from a purchaser; and associate the generated timed security code with at least a user profile of the purchaser in the database. It will be noted that this generated code may be stored in the database and may be compared with the code received via the merchant receiver module, i.e., the code that is either input in an alpha-numeric format into the merchant endpoint device, for example, by the merchant or party associated therewith (typically a human operator associated therewith) or read out aloud by the purchaser, merchant, or third party and recorded by the merchant endpoint device, as the case may be in order to process a particular transaction.

The code transmission module may be configured to transmit a generated timed security code to an endpoint device associated with a purchaser; and the merchant receiver module may be configured to receive a security code from a merchant having a user profile stored in the database. The merchant receiver module may be configured to:

receive a security code from a merchant having a user profile stored in the database;

determine whether or not the received security code is valid,

identify a user profile of a purchaser associated with the received security code if the security code is valid; and

retrieve at least some of the transaction data, and personal data associated with the identified user profile of the purchaser.

The financial transaction system may comprise:
a payment processing module configured to:
   generate and transmit a merchant acceptance message, comprising all or some of the retrieved data associated with a user profile identified by the merchant retriever module including payment method detail stored securely in the database, to the endpoint device associated with the merchant, wherein the merchant acceptance message prompts the merchant for an acceptance response for the transaction;
   generate and transmit a purchaser acceptance message to the endpoint device associated with the purchaser, wherein the purchaser acceptance message prompts the purchaser for an acceptance response for the transaction; and
   in response to receiving acceptance responses from the merchant and the purchaser, processing the transaction.

The system may comprise a registration module operable to register a user to the system by generating and storing in the database a user profile associated therewith in response to receiving personal data and payment account data associated with the user, wherein the users are one or both of purchasers and merchants.

The merchant receiver module may be configured to receive a selection of merchant terms and conditions applicable to a transaction from a merchant, wherein the purchaser must accept the merchant terms and conditions for the transaction in order for the transaction to be processed.

The system may be configured to provide the purchaser access to terms and conditions selected by the merchant for a transaction.

The merchant terms and conditions may be selected from a group of terms and conditions on an ad hoc basis per transaction or are predetermined.

The system may comprise a purchaser interaction module operable on the endpoint device associated with the purchaser; and a merchant interaction module operable on the endpoint device associated with the merchant, wherein the purchaser interaction module is configured to receive and transmit data between the one or more processors and the endpoint device associated with the purchaser, and wherein the merchant interaction module is configured to receive and transmit data between the one or more processors and the endpoint device associated with the merchant.

It will be appreciated that the security code may be displayed via the purchaser interaction module for a predetermined period of time on the endpoint device associated with the purchaser. For example, the code may be displayed for 30 seconds such that the purchaser has enough time to vocalize the same.

The merchant acceptance message may comprise at least some transaction data and personal data associated with the purchaser, and wherein the purchaser acceptance message may comprise at least personal data associated with the purchaser.

The payment processing module may be operable to communicate with a financial institution associated with an account of the purchaser to facilitate one or both of a payment or an authorization to an account associated with the merchant.

The purchase receiver module may be configured to receive transaction data from a mobile wallet provider.

The security code generating module may be configured to generate a security code in response to receiving transaction data from a mobile wallet provider.

The code transmission module may be operable to transmit a generated security code to a mobile wallet provider for transmission to a purchaser.

The merchant receiver module may be operable, in response to determining that a received security code is valid, to transmit a suitable message to the mobile wallet provider to process the associated transaction.

According to a second aspect of the invention, there is provided a method of operating a financial transaction system comprising:
maintaining a database storing data in a secure fashion;
receiving, via a purchaser receiver module, transaction data associated with a transaction for one or both of payment and authorization of a financial amount from a purchaser to a merchant, wherein received transaction data comprises information selected from a group comprising identifier information associated with the purchaser, a financial amount associated with the transaction, financial currency associated with the transaction, and a transaction identifier identifying the transaction;
generating, via a security code generating module, a timed security code, valid for a pre-determined period of time, in response to receiving the transaction data, wherein the generated timed security code is linked to the transaction;
transmitting, via a code transmission module, the generated security code for use by the purchaser wherein, in use, the security code is provided by the purchaser to a merchant in order to process a transaction associated with the security code;
receiving, via a merchant receiver module, the security code transmitted by the merchant at a merchant endpoint device, wherein the security code transmitted by the merchant is received thereby from the purchaser in respect of a transaction; and
determining, via the merchant receiver module, whether the security code received thereby is valid, or not, so as to allow or deny the associated transaction or facilitate processing the transaction.

The security code may be as described above. To this end, the method may comprise the step of recording the audible version of the security code, i.e., the security code read out aloud by the purchaser, merchant, or third party with the merchant endpoint device and transmitting the same to the merchant receiver module which receives the same so as to determine if the audible version matches that stored in the database.

As mentioned above, the database may be configured to store data comprising a plurality of user profiles associated with one or both of purchasers and merchants, wherein the user profiles stores account data associated with one or more external financial accounts associated with the purchasers and merchants as well as personal data associated therewith, and wherein the method may further comprise:
receiving transaction data from the purchaser having a user profile stored in the database, wherein the received transaction data comprises information indicative of the financial account from which the purchaser desires to one or both of pay and authorize the financial amount;
associating the received transaction data with a user profile of the purchaser stored in the database;
generating the timed security code in response to receiving transaction data from the purchaser;
associating the generated timed security code with at least the user profile of the purchaser in the database;
transmitting the generated timed security code to an endpoint device associated with the purchaser; and
receiving a security code from a merchant having a user profile stored in the database;
determining whether or not the received security code is valid,
identifying a user profile of a purchaser associated with the received security code if the security code is valid;
retrieving at least some of the transaction data, and personal data associated with the identified user profile of the purchaser;
generating and transmitting a merchant acceptance message, comprising all or some of the retrieved data associated with the identified user profile, to the endpoint device associated with the merchant, wherein the merchant acceptance message prompts the merchant for an acceptance response for the transaction on specific terms and conditions;
generating and transmitting a purchaser acceptance message to the endpoint device associated with the purchaser, wherein the purchaser acceptance message prompts the purchaser for an acceptance response for the transaction; and
in response to receiving acceptance responses from the merchant and the purchaser, processing the transaction.

The method may comprise registering a user to the system by generating and storing in the database a user profile associated therewith in response to receiving personal data and payment account data associated with the user.

The method may comprise receiving a selection of merchant terms and conditions applicable to a transaction from a merchant, and wherein the method comprises receiving acceptance of the merchant terms and conditions from the purchaser for the transaction in order for the transaction to be processed. The acceptance of the terms and conditions by the purchaser may be also a verbal acceptance which may be recorded by the merchant endpoint device and stored accordingly. Thus a verbal record is maintained of the transaction, or at least part thereof.
The method may comprise providing the purchaser with access to terms and conditions selected by the merchant for a transaction.

The merchant terms and conditions may be selected from a group of terms and conditions on one or both of an ad hoc basis per transaction and are predetermined per transaction.

The method may comprise displaying the security code for a predetermined period of time on the endpoint device associated with the purchaser.

The method may comprise:
receiving transaction data from a mobile wallet provider;
generating the security code in response to receiving transaction data from a mobile wallet provider;
transmitting the generated security code to the mobile wallet provider for transmission to a purchaser; and
in response to determining that a received security code is valid, transmitting a suitable message to the mobile wallet provider to process the associated transaction.

According to a third aspect of the invention, there is provided a non-transitory computer readable medium storing a set of computer executable instructions which when executed by one or more processors cause the same to:
maintain a database storing data in a secure fashion;
receive transaction data associated with a transaction for one or both of payment and authorization of a financial amount from a purchaser to a merchant, wherein received transaction data comprises information selected from a group comprising identifier information associated with the purchaser, a financial amount associated with the transaction, financial currency associated with the transaction, and a transaction identifier identifying the transaction;
generate a timed security code, valid for a pre-determined period of time, in response to receiving the transaction data, wherein the generated timed security code is linked to the transaction;
transmit the generated security code for use by the purchaser wherein, in use, the security code is provided by the purchaser to a merchant in order to process a transaction associated with the security code;
receive the security code transmitted by the merchant at a merchant endpoint device, wherein the security code transmitted by the merchant is received thereby from the purchaser in respect of a transaction; and
determine whether the security code received thereby is valid, or not, so as to allow or deny the associated transaction.

According to a fourth aspect of the invention, there is provided a financial transaction system comprising:

a secure database configured to store data including a plurality of user profiles associated with one or both of purchasers and merchants, wherein the user profiles stores account data associated with one or more external financial accounts associated with the users as well as personal data associated therewith; and

one or more processors comprising:
a purchaser receiver module configured to:
   receive transaction data associated with a transaction for the payment or authorization of a financial amount from a purchaser having a user profile to a merchant, wherein the transaction data comprises information indicative of one or
more of the financial amount associated with the transaction, the financial account from which the purchaser desires to pay or authorize the financial amount, and a transaction identifier identifying the transaction; and
   associate the received transaction data with the user profile of the purchaser stored in the database;
a security code generating module configured to:
   generate a timed security code in response to receiving the transaction data from the purchaser; and
   associate the generated timed security code with at least the user profile of the purchaser in the database, wherein the timed security code is valid for a predetermined period of time;
a code transmission module operable to transmit the generated timed security code to an endpoint device associated with the purchaser;
a merchant receiver module operable to:
   receive a timed security code from an endpoint device associated with a merchant having a user profile, wherein the timed security code received by the merchant is associated with the purchaser;
   determine whether the timed security code received from the merchant is valid;
   in response to the determining that the timed security code is valid, identify the user profile of the purchaser associated with the timed security code;
retrieve at least some of the transaction data, and personal data associated with the identified user profile of the purchaser;
and
a payment processing module configured to:
   generate and transmit a merchant acceptance message, comprising all or some of the retrieved data associated with the identified user profile including payment method detail stored securely in the database, to the endpoint device associated with the merchant, wherein the merchant acceptance message prompts the merchant for an acceptance response for the transaction;
   generate and transmit a purchaser acceptance message to the endpoint device associated with the purchaser, wherein the purchaser acceptance message prompts the purchaser for an acceptance response for the transaction; and
   in response to receiving acceptance responses from the merchant and the purchaser, processing the transaction.

According to a fifth aspect of the invention, there is provided a method of operating a financial transaction system, the method comprising:

maintaining a secure database configured to store data including a plurality of user profiles associated with one or both of purchasers and merchants, wherein the user profiles stores account data associated with one or more external financial accounts associated with the users

as well as personal data associated therewith;

receiving transaction data associated with a transaction for the payment or authorization of a financial amount from a purchaser having a user profile to a merchant, wherein the transaction data comprises information indicative of one or more of the financial amount associated with the transaction, the financial account from which the purchaser desires to pay or authorize the

financial amount, and a transaction identifier identifying the transaction;

associating the received transaction data with the user profile of the purchaser stored in the database;

generating a timed security code in response to receiving the transaction data from the purchaser;

associate the generated timed security code with at least to the user profile of the purchaser in the database, wherein the timed security code is valid for a predetermined period of time;

transmitting the generated timed security code to an endpoint device associated with the purchaser;

receiving a timed security code from an endpoint device associated with a merchant having a user profile;

determining whether the timed security code received from the merchant is valid;

in response to determining that the timed security code is valid, identifying the user profile of the purchaser associated with the timed security code;

retrieving at least some of the transaction data, and personal data associated with the identified user profile of the purchaser;

generating and transmitting a merchant acceptance message, comprising all or some of the retrieved data associated with the identified user profile, to the endpoint device associated with the merchant, wherein the merchant acceptance message prompts the merchant for an acceptance response for the transaction on specific terms and conditions;

generating and transmitting a purchaser acceptance message to the endpoint device associated with the purchaser, wherein the purchaser acceptance message prompts the purchaser for an acceptance response for the transaction; and

in response to receiving acceptance responses from the merchant and the purchaser, processing the transaction.

According to a sixth aspect of the invention, there is provided a financial transaction system comprising:

a database configured to securely store data; and

one or more processors comprising:
a purchaser receiver module configured to:
   receive transaction data associated with a transaction for the payment or authorization of a financial amount from a purchaser to a merchant, wherein the transaction data is received from a mobile wallet provider and comprises information selected from a group comprising identifier information associated with the purchaser, the financial amount associated with the transaction, the currency associated with the transaction, and a transaction identifier identifying the transaction;

a security code generating module configured to generate a timed security code in response to receiving the transaction data from the mobile wallet provider; and

a code transmission module operable to transmit the generated timed security code to the mobile wallet provider for transmission to the purchaser.

The system may optionally comprise a merchant receiver module operable to:
receive a timed security code from an endpoint device associated with a merchant, wherein the timed security code received by the merchant is associated with the purchaser;
determine whether the timed security code received from the merchant is valid;
in response to determining that the timed security code is valid, transmit a suitable message to the mobile wallet provider to process the transaction.

According to a seventh aspect of the invention, there is provided a method of operating a financial transaction system, the method comprising:

maintaining a database securely storing data;

receiving transaction data associated with a transaction for the payment or authorization of a financial amount from a purchaser to a merchant, wherein the transaction data is received from a mobile wallet provider and comprises information selected from a group comprising identifier information associated with the purchaser, the financial amount associated with the transaction, and a transaction identifier identifying the transaction;

generating a timed security code in response to receiving the transaction data from the mobile wallet provider;

transmitting the generated timed security code to the mobile wallet provider for transmission to the associated purchaser.

The method may comprise:
receiving a timed security code from an endpoint device associated with a merchant, wherein the timed security code received by the merchant is associated with the purchaser;
determining whether the timed security code received from the merchant is valid:
in response to determining that the timed security code is valid, transmitting a suitable message to the mobile wallet provider to process the transaction.

### BRIEF DESCRIPTION OF THE DRAWINGS

FIG. 1 shows a schematic drawing of a transaction system in accordance with an example embodiment of the invention;

FIG. 2 shows a schematic drawing of a system in accordance with an example embodiment of the invention in more detail;

FIG. 3 shows a process flow diagram of a method of operating a transaction system in accordance with an example embodiment of the invention;

FIG. 4 shows a screen shot of an example user interface in accordance with an example embodiment of the invention;

FIG. 5 shows a screen shot of an example user interface in accordance with an example embodiment of the invention;

FIG. 6 shows a screen shot of an example user interface in accordance with an example embodiment of the invention;

FIG. 7 shows a screen shot of an example user interface in accordance with an example embodiment of the invention;

FIG. 8 shows a screen shot of an example user interface in accordance with an example embodiment of the invention;

FIG. 9 shows a screen shot of an example user interface in accordance with an example embodiment of the invention;

FIG. 10 shows a screen shot of an example user interface in accordance with an example embodiment of the invention;

FIG. 11 shows a screen shot of an example user interface in accordance with an example embodiment of the invention;

FIG. 12 shows a screen shot of an example user interface in accordance with an example embodiment of the invention;

FIG. 13 shows a screen shot of an example user interface in accordance with an example embodiment of the invention;

FIG. 14 shows a screen shot of an example user interface in accordance with an example embodiment of the invention;

FIG. 15 shows a screen shot of an example user interface in accordance with an example embodiment of the invention;

FIG. 16 shows a schematic drawing of another transaction system in accordance with an example embodiment of the invention;

FIG. 17 shows a schematic drawing of the system of FIG. 16 in more detail; and shows a diagrammatic representation of a machine in the example form

FIG. 18 of a computer system in which a set of instructions for causing the machine to perform any one or more of the methodologies discussed herein, may be executed.

### DETAILED DESCRIPTION OF THE DRAWINGS

In the following description, for purposes of explanation, numerous specific details are set forth in order to provide a thorough understanding of an embodiment of the present disclosure. It will be evident, however, to one skilled in the art that the present disclosure may be practiced without these specific details.

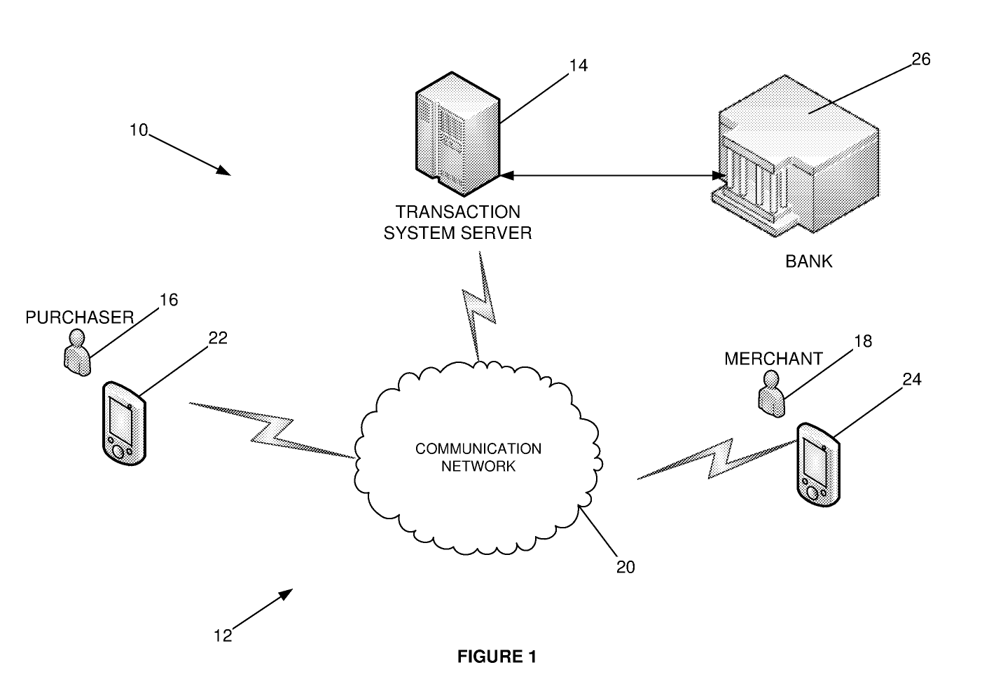

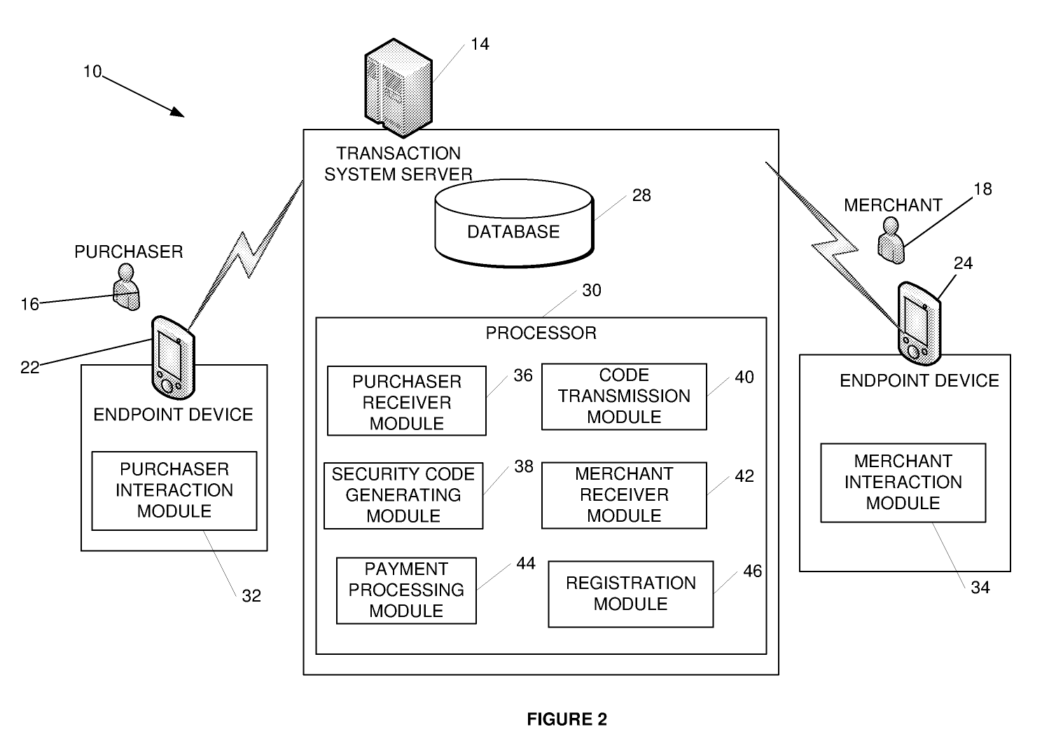

Referring to FIGS. 1 and 2 of the drawings, a network comprising a system 10 in accordance with an example embodiment of the invention is generally indicated by reference numeral 12. The system 10 is an electronic transaction system comprising a transaction system server 14 connectable to users of the system 10, for example, a purchaser 16 and a merchant 18 via a communication network 20. The system 10 facilitates transactions for the payment or authorization of payment between the purchaser 16 and the merchant 18, for example, for booking for a particular service such as a hotel or restaurant reservation. In particular, the system 10 is configured to facilitate the said transaction whilst the purchaser 16 is conversing with the merchant 18, for example, telephonically, or in person. The purchaser 16 and the merchant 18 may be able to facilitate the transaction via associated endpoint devices 22, 24, respectively, operatively connected to a communication network 20 as will be described below.

The communication network 20 may be a cellular or mobile telecommunication network. Instead, or in addition, the communication network 20 may be a packet-switched network and may form part of the Internet. Instead, the communication network 20 may be a circuit switched network, public switched data network, or the like. The devices 22, 24 may be matched to the communication network 20. Instead, in addition, it will be noted that the devices 22, 24 may be operable to connect to other communication networks, not illustrated. In one example 10 embodiment, the endpoint devices 22, 24 may be in the form of mobile computing devices in the form of smart telephones, tablet computing devices, and the like comprising suitable hardware operable to connect to the communication network 20.

Though FIGS. 1 and 2 illustrate a single purchaser 16 and merchant 18, the network 12 may comprise a plurality of purchasers 16 and merchants 18. In addition, the terms purchaser 16 and merchant 18 may be understood to include agents of the same, for example, if the merchant 18 is a retailer, then an agent thereof, for example, a teller of the retailer may be considered a merchant for the purposes of the description herein. In addition, in example embodiments, the purchaser 16 may additionally be merchants 18, and viceversa.

The server 14 may be communicatively coupled to one or more financial institutions or banks 26 associated with the purchasers 16 and merchants 18, particularly to payment gateways thereof in a conventional fashion. The server 14 may be one or more networked servers or application servers operatively connectable to the communication network 20. In this way, the functionality provided by the server 14 may be a cloud-based computing functionality.

Referring now, in particular to FIG. 2, the system 10 comprises a database 28 configured to store data including a plurality of user profiles associated with purchasers 16 and merchants 18 associated with, or in particular, registered with the system 10 as registered users. The user profiles stores account data associated with one or more external financial accounts associated with the users 16, 18 at the bank 26 as well as personal data associated therewith. The account data may serve to identify one or more accounts associated with the users 16, 18 at the institution 26 or an external payment entity or platform. The personal data may comprise one or more of the name, address, contact details, such as, email addresses, and telephone or mobile phone numbers, etc. associates with the users 16, 18.

The system 10 further comprises at least one processor 30 comprising a plurality of components and modules which correspond to at least some of the functional tasks to be performed by the system 10. In this regard, the term “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices, for example, on a plurality of networked servers at the same location or at spaced apart geographic locations in the network 12.

It will be noted that the processor 30 may be programmed with software to control respective modules and components to achieve the desired functionality described herein. To this end, the database 28 (or memory in the processor 30, main memory, and/or a hard disk drive) may carry a set of non-transitory computer executable instructions to direct the operation of the processor 30 in a fashion as described herein. It will be understood that the processor 30 may be one or more microprocessors, controllers, or any other one or more suitable computing devices, resources, hardware, software, or embedded logic.

The system 10 further comprises a purchaser interaction module 32 and a merchant interaction module 34 operatively located in the endpoint device 22 and 24 of the purchaser 16 and merchant 18 respectively. The modules 32, 34 may be in the form of software application modules downloadable to the purchaser and merchant endpoint devices 22, 24 and may facilitate receipt and transfer of data to and from the server 14. To this end the modules 32, 34 may be configured to receive data from the users 16, 18 and transmit the same to the server 14 and receive data from the server 14 and display the same to the users 16, 18. In addition, it will be appreciated that in some example embodiments, some of the functionality of some of the modules as will be described with reference to the server 14, particularly the processor 30, may be carried out by the modules 32, 34 as the case may be.

In any event, the processor 30 comprises a purchaser receiver module 36 configured to receive transaction data associated with the transaction for the payment or authorization of a financial amount from the purchaser 16 to the merchant 18. The transaction data typically comprises information indicative of the financial amount associated with the transaction, the financial account from which the purchaser 16 desires to pay or authorize the financial amount, and a transaction identifier identifying the transaction. The transaction data may be input by the purchaser 16 via the module 32 on their endpoint device 22 and may be transmitted to the module 36 via the communication network 20. The module 32 may prompt the purchaser 16 for the financial amount, and the account which the purchaser 16 desires to transact from. It will be noted that the account may include a payment method, for example, if the account selection is a credit card, the module 32 may prompt the purchaser 16 for security code associated with said card. The purchaser 14 may also select the current of the financial amount. The transaction identifier may be system generated so as to identify the transaction from other transactions which the purchaser 16 may be involved in by way of the system 10.

The purchaser receiver module 36 may be further configured to associate the received transaction data with the user profile of the purchaser 16 stored in the database 28.

The processor 30 further conveniently comprises a security code generating module 38 configured to generate a unique timed security code in response to receiving the transaction data from the purchaser 16 via the device 22. For brevity, it will be noted that the receipt and transmission of data to and from the users 16, 18 may be via their respective endpoint devices 22, 24 unless otherwise indicated. The timed security code is typically valid for a pre-determined period of time, for example, two minutes. The module 38 may comprise a clock and may allocate a time stamp to the code which is valid for the pre-determined period of time. The timed security code may be one or a combination of a numeric and character code which may in one example embodiment be randomly generated by the module 38.

The module 38 may be configured to associate the generated timed security code with at least to the user profile of the purchaser 16 in the database 28.

The processor 30 further comprises a code transmission module 40 operable to transmit the generated timed security code to the endpoint device 22 associated with the purchaser 16. The code may be pushed to a display screen associated with the endpoint device 22 associated with the purchaser 16 and may be displayed for a predetermined period of time. In one example embodiment, the module 32 may be configured to display the code and may cease displayed the code after a pre-determined period of time has elapsed, for example, by utilizing a clock associated with the device 22 and a time stamp associated with the code. Similarly, the module 40 may be configured to control the display of the code for a pre-determined period of time.

It will be appreciated that the code displayed on the display screen of the device 22 may be verbally communicated to the merchant 18 by the purchaser 16, the merchant 18 then using the received code by inputting the same to the module 34 in response to the module 34 prompting the merchant 18 for input of the code.

The processor 30 may comprises a merchant receiver module 42 operable to receive the timed security code from the endpoint device 24 associated with the merchant 18 and determine whether the timed security code received from the merchant 18 is valid. For example, this may be done by interrogating the time in which the timed security code was received and the time in which the code was transmitted and/or generated, and wherein if the difference in time between when the timed security code was received and the time in which the code was transmitted and/or generated exceeds the pre-determined valid period of time, then the code is invalid. In other words, if the difference of time in which the code was transmitted and/or generated and was received by the module 42 is five minutes and the predetermined valid period is two minutes then the received code may be found to be invalid. Conversely, if the said difference of time is less than the pre-determined valid period then the received code may be found to be valid. It will be noted that determining the validity of the code may be done in a myriad of different, for example, this may be an operation undertaken by the module 34 utilizing a clock associated with the endpoint device 24 and a time stamp associated with the code. Instead, or in addition, to the code being received in a good time, the processor 30 may compare the received code to that stored in the database associated with a purchaser 16.

Whatever the validation, it will be appreciated that the code generated has a limited period of validity and thus use thereof outside the period of validity, which may be determined in a plurality of ways, would prove invalid. The limited period of validity is part of the security mechanism deployed to prevent unauthorized and/or fraudulent access to payments.

In response to the determining that the timed security code is valid, the module 42 may be operable to identify the user profile of the purchaser 16 associated with the timed security code; and retrieve at least some of the transaction data, and personal data associated with the identified user profile of the purchaser, for example, at least the name of the purchaser 16 and the financial amount associated with the desired transaction. It will be noted that in example embodiments where the code is compared with codes stored in the database, a security code match of a code received within a pre-determined time against a particular code stored in the database and uniquely associated with a purchaser would locate the relevant user profile already, as the case may be. In this regard, it will be appreciated again that the code may be verified and the purchaser user profile retrieved in many ways in order to process the transaction.

The processor 30 may further comprise a payment processing module 44 configure to generate and transmit, via a push operation, a merchant acceptance message, comprising all or some of the retrieved data associated with the identified user profile (i.e., the name of the purchaser 16 and financial amount), to the endpoint device 24 of the merchant 18. The merchant acceptance message prompts the merchant 18 for an acceptance response for the transaction via the module 32 operating on the endpoint device 24.

Moreover, the module 44 may also be configured to generate and transmit, also via a push operation, a purchaser acceptance message to the endpoint device 22 associated with the purchaser 16. The purchaser acceptance message prompts the purchaser 16 for an acceptance response for the transaction. The purchaser acceptance message identifies the merchant and the terms and conditions specified by the merchant for the intended transaction. This allows the opportunity for both the merchant 18 and the purchaser 16 to decline the transaction before the same is processed, thereby facilitating a more secure transaction.

In response to receiving acceptance responses from the merchant 16 and the purchaser 18, the payment processing module 44 is configured to process the transaction in a conventional manner. To this end, the module 44 may be communicatively coupled to a payment gateway or back-end financial system associated with the banks 26 so that, for example, a payment is made or an authorization is granted from the selected account of the purchaser 16 to the merchant 18 for the selected financial amount.

The system 10 may comprise a registration module 46 configured to facilitate a user registering a user profile in the database 28. In this regard, the registration module 46 may assign or may receive a selected unique user name and password so that the users 14, 16 may securely log in to the system 10 via the modules 32, 34 respectively. It will be noted that account details such as card numbers stored in the database 28 may be stored in a PCI DSS (Payment Card Industry) compliant token vault (no security codes are stored). As part of the registration, or at any time thereafter, a user 16, 18 may vary or amend the information on their profile. For example, a purchaser 16 may select the personal details which they would like to share electronically with the merchant 18 in order to facilitate accurate processing of a transaction.

The merchant 18 as part of their registration may, by way of the module 46 create rules or in other words terms and conditions which the purchaser 16 must accept, for example, as part of the purchaser acceptance message in order for the module 44 to proceed with the transaction. Such terms and conditions would typically include refund conditions set by the merchant.

The processor 30 may also comprise a dashboard module 48 operable to retrieve and transmit to the purchaser 16 and the merchant 18 a listing of all transactions processed or in progress to be processed which are linked to their user profiles in the database 28. In this way, the purchaser 16 and merchant 18 are able to keep track of the transactions made and/or are being processed.

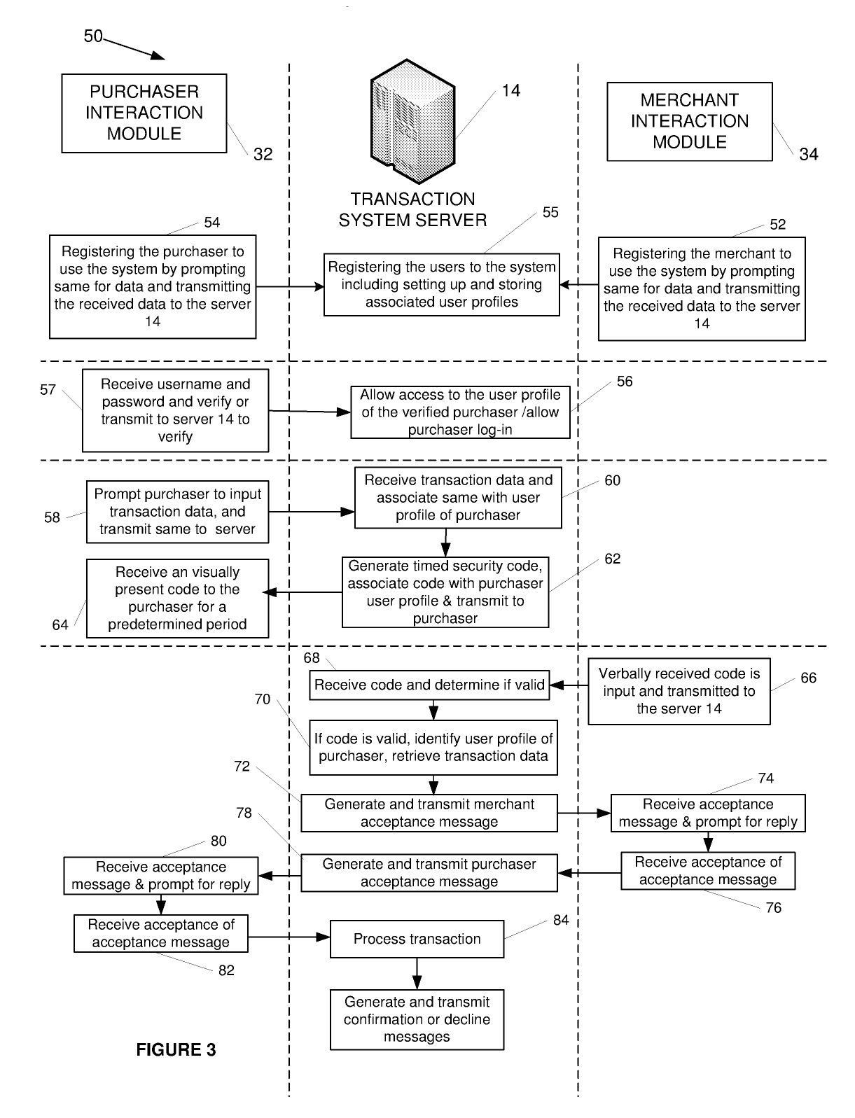

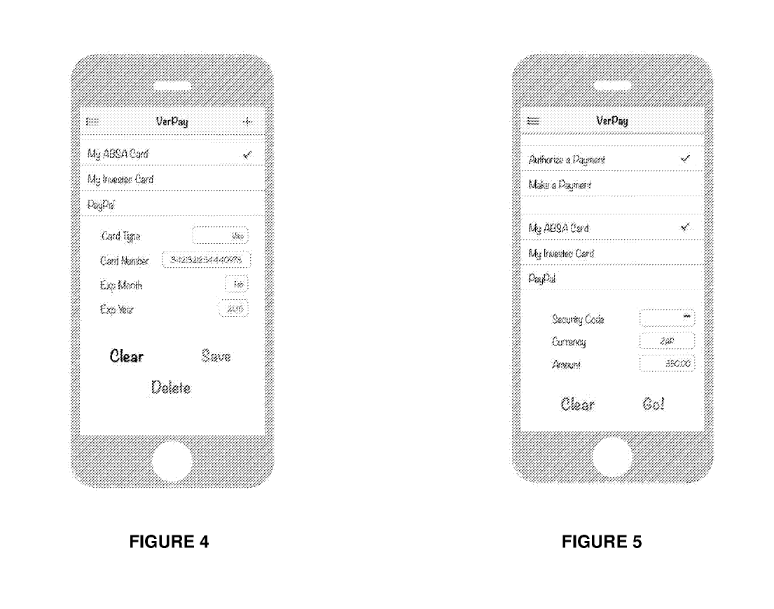

Example embodiments will now be further described in use with reference to FIGS. 3 to 15. The example method shown in FIG. 3 is described with reference to FIGS. 1 & 2, although it is to be appreciated that the example methods may be applicable to other systems, not illustrated, as well. The screen shot illustrations shown in FIGS. 4 to 15 may be exemplary screen shots of graphical user interfaces (GU's) generated or provided by the modules 32, 34, as the case may be. In addition, further functionality of the system 10 as described above may be supplemented by the description which follows.

Though not illustrated or discussed further in great detail, it will be appreciated that the system 10, particularly the server 14 may comprise suitable security modules, firewalls, etc. so as to maintain the security and integrity of the data stored in the database 28.

Referring to FIG. 3 in detail where a line/process flow diagram of a method in accordance with an example embodiment of the invention is generally indicated by reference numeral 50. The method 50 is described with reference to the FIGS. 4 to 15 so as to assist in facilitating the understanding of the invention.

The method 50 may be described with reference to a transaction which requires payment of a particular financial amount in order to secure a booking for a particular service, such as a spa treatment offered by the merchant 18, whilst the purchaser 16 is telephonically engaged with the merchant 18, particularly a human operator thereof. In this example embodiment, the communication network 20 is typically a data network and the purchaser 16 is telephonically engaged with the merchant 18 via another communication channel such as a fixed line telephony network.

Though not shown, it will be appreciated that the method 50 may comprise the users 16, 18 downloading the software applications in the form of the module 32, 34 onto their respective devices 22, 24. As alluded to herein, the users 16, 18 may access the system 10 particularly the server 14 via any device having the modules 32, 34 thereon using their user name and password. In one example embodiment, the modules 32, 34 may be substantially similar, for example, wherein the purchaser 16 and merchant 18 are the same. Alternatively, the modules 32, 34 may be sufficiently different modules uniquely tailored for the purchaser 16 and merchant 18.

In any event, the method 50 typically comprises a prior step 52 of the merchant 18 registering via the module 34 to use the server 14 by setting up a user profile. The module 34 downloaded onto their computing endpoint device 24. In any event, the registration module 46 is configured to receive account data and personal data from the merchant 18 via the module 34 over the communication network 20 so as to register, at step 55, and create a user profile for the merchant 18 for storage and maintenance in the database 28. As illustrated in FIG. 4, the account data may be account details of bank accounts, cards (such as debit, credit, cheque cards, particularly their numbers, expiry date), etc. of financial institution 26 associated with the merchant 18 and the personal information may comprise the name, address, contact details of the merchant. As mentioned above, the merchant 18 may set, via the module 46 one or more terms and conditions to be accepted by the purchaser 16 before a transaction is processed. The payment method details associated with the purchaser 16 may also be received and stored in the database 28.

It will be understood that the merchant 18 may have more than one user profile in the database 28, as the case may be. In addition, the system 10 provides multiple access nodes to at least one user profile associated with the merchant 18, in which case certain account information associated with the merchant 18 may require additional permissions to access, edit, etc. In this example embodiment, a merchant having a plurality of agents or operators may be able to access or use at least part of the system 10 from a plurality of endpoint devices 24.

As mentioned above, account details are stored in a PCI DSS compliant token vault and no security codes associated with bank cards are stored. Bank cards may be added or deleted relatively easily.

The merchant 18 may typically log-on to the system 10 in a secure fashion by using their user names and passwords which have been pre-allocated and/or user selected.

Similarly, it will be appreciated that the method 50 comprises a step 54 of the purchaser using the module 32 to register themselves to the system 10 via the module 46 by creating a user profile in a similar fashion as described above with reference to step 52 and 55.

In any event, when the purchaser 16 having a user profile, or in other words a registered user of the system 10, is engaged telephonically with the merchant 18 and wishes to facilitate a transaction for the payment of a deposit to the merchant 18, they access the system server 14 or in other words login to at least part of the system 10 by entering their username and password into the module 32. The method 50 therefore comprises receiving, at step 57 via the module 32, the username and password of the purchaser 16, verifying the same, and allowing the verified purchaser 16 to access the associated user profile, at step 56. It follows that if the username and password are not verified, the purchaser 16 will not be able to use the module 32 or the functionality of at least part of the system 10. When the user 16, 18 has access to their user profile, they may vary the data therein accordingly, for example, edit or change account details, etc.

It will be noted that in some example embodiments, the username and password received by the module 32 is transmitted for verification to the server 14. It will be understood that once verified and the user 16 is logged in to the system 10, they may utilize the functionality of the system as described herein, for example, for facilitating the aforementioned transaction.

In some example embodiments, the purchaser 16 may use personal biometrics such as fingerprint authentication or a social media login via an OAuth application to gain access or login to the system 10.

In any event, when the purchaser 16 uses the module 32 for facilitating a transaction, the method 50 may comprise prompting, at step 58 via the module 32, the purchaser 16 for data as illustrated in FIG. 5. In particular, the method 50 may comprise prompting the purchaser 16, by way of the module 32, to input into the module 32, transaction data, comprising an indication of the nature of the transaction, for example, a payment authorization or payment, a selection of the financial account which the purchaser desires to transact from, a security code if the credit card is selected, payment method, as well as the currency of the transaction and financial amount of the transaction for the payment to the merchant 18.

The method 50 comprises the step 60 of receiving at the server 14, the transaction data transmitted by the module 32 by way of the purchaser receiver module 36 as described above. Also, in step 60, the method 50 comprises operating the module 36 to associate the received transaction data with the relevant user profile of the purchaser 16 in a manner as described above.

In response to receiving the transaction data from the module 32 associated with the purchaser 16, the method 50 may comprise generating, at step 62 by way of the code generating module 38, a timed security code in the manner as described above. The method 50, also at step 62, comprises operating the module 38 to associate the generated timed security code with the user profile of the purchaser 16.

The method 50 then comprises transmitting, also at step 62, the generated timed security code to the endpoint device 22, particularly the module 32 over the communication network 2 by way of the module 40.

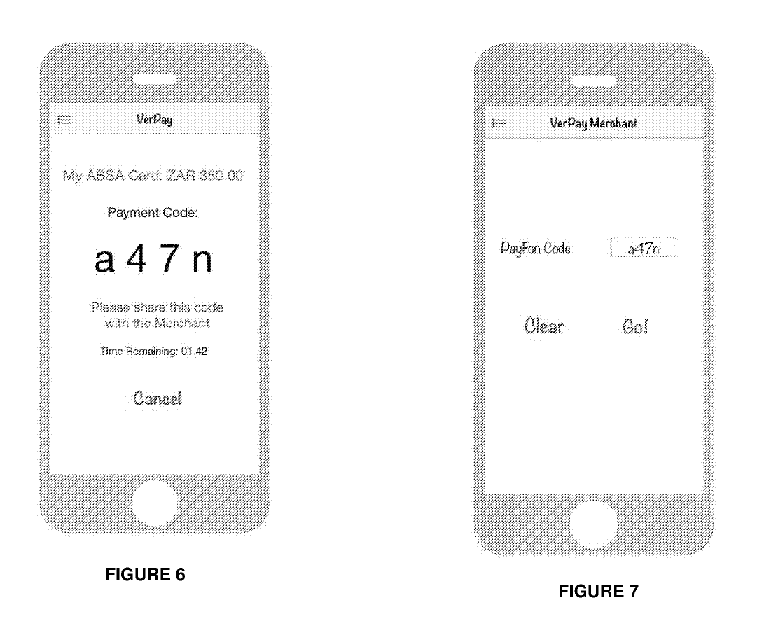

The method 50 comprises receiving and displaying, at step 64, the security code for a pre-determined period of time on the display screen of the endpoint device 22 by way of the module 32 on the device 22, as illustrated in FIG. 6. In this way, it will be noted that for security purposes, the code has a pre-determined time-based period in which the same is valid as hereinbefore described. In some example embodiments, the code may be displayed for a predetermined time period only and will cease to display once said period is over.

As mentioned above, the module 40 may control the display of the code for the pre-determined period of time or the module 32 may do so.

It will be appreciated that in response to receiving the code, the purchaser 16 verbally provides the code to the merchant 18 over the telephone as opposed to giving the same their account data.

The method 50 therefore comprises receiving the verbally received code, at step 66, wherein the code is input into the module 34 by the merchant 18, as illustrated in FIG. 7. In some example embodiments, not illustrated, the code received audibly by the merchant 18 is input into the merchant point of sale terminal or business application integrated to the server 14. As alluded to above, in some example embodiments, this code may be spoken in an oral fashion by the purchaser 16 and may be recorded by the merchant 18 by the merchant endpoint device, particularly the software application running thereon.

The method 50 comprises receiving the code, at step 38, by the module 42 from the module 34 via the communication network 20 and in response thereto, the module 42 determines whether the timed security code received from the merchant is valid, at step 70, for example, in a manner described above.

It will be appreciated that in response to determining that the timed security code is valid, the method 50 comprises, at step 70 via the module 42, identifying the user profile of the purchaser 16 associated with the timed security code, and retrieving at least some of the transaction data, and personal data associated with the identified user profile of the purchaser 15. Though not described in detail, if the code is for any reason invalid, the method 50 may comprise communicating said invalidity to the user 16, 18. The method 50 may comprise prompting the merchant 18 for the terms and conditions of the transaction.

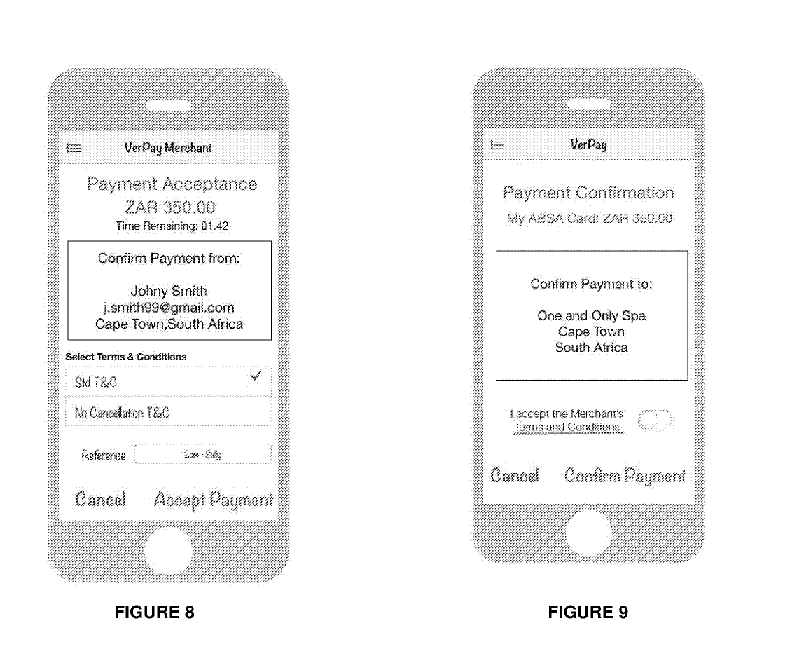

The method 50 then comprises generating, at step 72, a merchant acceptance message as illustrated in FIG. 8 via the module 44. The method 50 also comprises transmitting, at step 72 by way of the module 44, the generated merchant acceptance message to the module 34 via the communication network 20.

The merchant acceptance message comprises at least some of the retrieves transaction data, and personal data, for example, the financial amount, the user name, and contact information. The merchant acceptance message may comprise a field for merchant use as well as terms and/or conditions set, for example, by the purchaser, which the merchant 18 may accept. The method 50 may comprise receiving the message at the module 34 and prompting merchant 18 for a reply, at step 74.

In response to receiving an acceptance response, at step 76, from the merchant 18 to the merchant acceptance message, the method 50 comprises generating and transmitting, at step 78 via the module 44, a purchaser acceptance message, as illustrated in FIG. 9, to the module 32 associated with the purchaser 16. The purchaser acceptance message prompts the purchaser 16 for a final confirmation of the transaction, wherein the message comprises the details of the merchant 18, financial amount, as well as terms and/or conditions for the transaction set, for example, by the merchant 18.

The method 50 comprises receiving the acceptance message at the module 32 in step 80 and prompting the purchaser 16 for a response. The method 50 also comprises prompting the purchaser 16 for acceptance of the terms and conditions of the transaction.

In response to receiving an acceptance response, at step 82, from the purchaser 16 to the purchaser acceptance message, the method 50 comprises processing the transaction, at step 84, to affect the payment of the financial amount from the account at the bank 26 selected by the purchaser 16 to the bank account of the merchant 18 by way of the module 44.

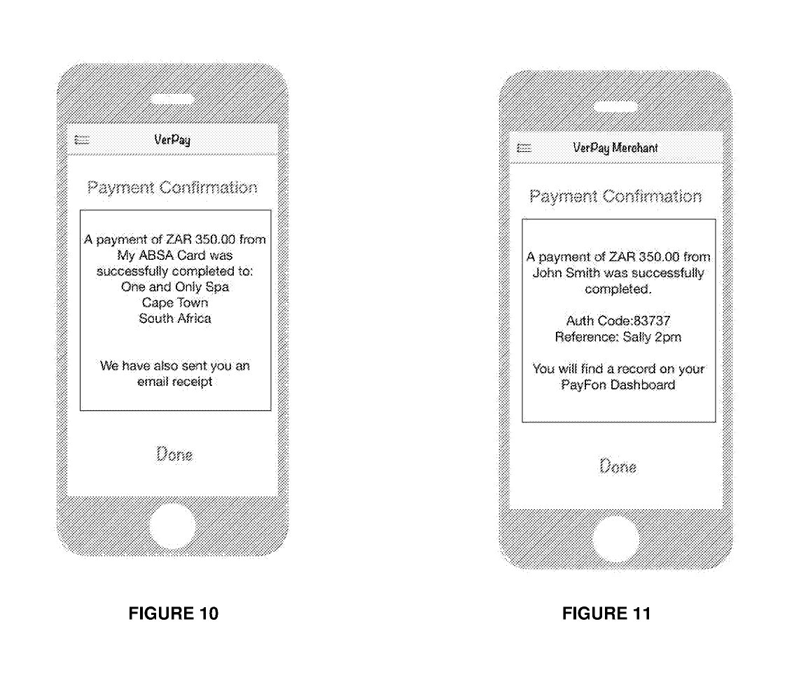

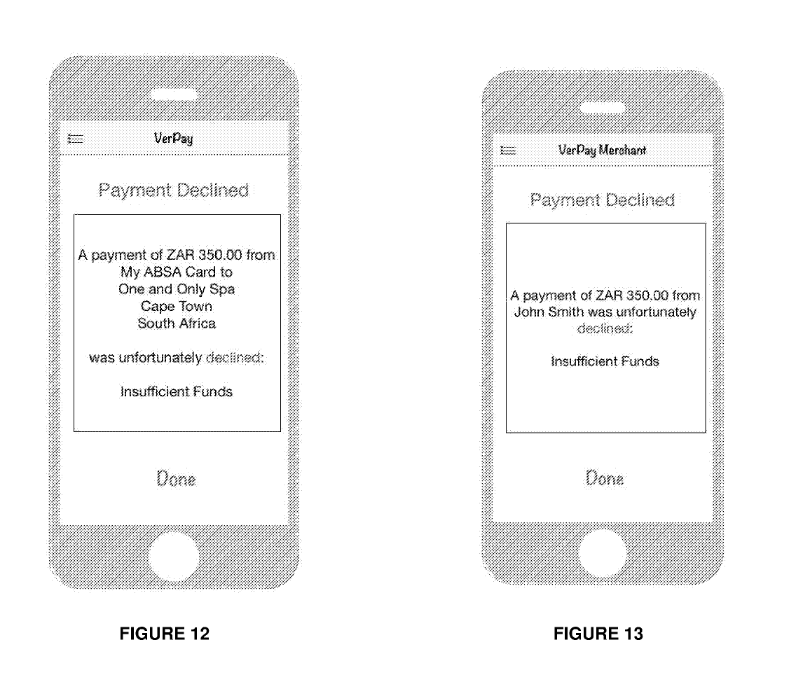

Once the transaction has been processed and payment has been made, the method 50 may comprise generating and transmitting, at step 86, for example, via the module 44 a confirmation message to the purchaser 16 and merchant 18 as illustrated in FIGS. 10 and 11, particularly to the devices 22 and 24. Similarly, if there is a problem with the processing the transaction, the module 44 generates and transmits, at step 86, a declined message to the purchaser 16 and merchant 18 as illustrated in FIGS. 12 and 13.

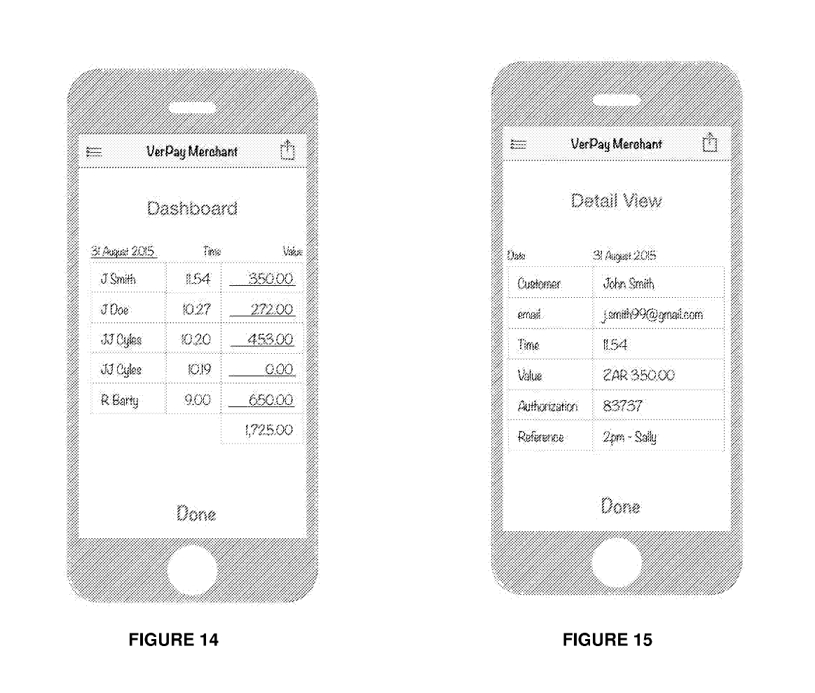

Using the dashboard module 48, it will be noted that the merchant 18 may view a list of transactions processed for a particular period as illustrated in FIG. 14. As may be seen in FIG. 15, the merchant 18 may drill down for more detail on any transaction.

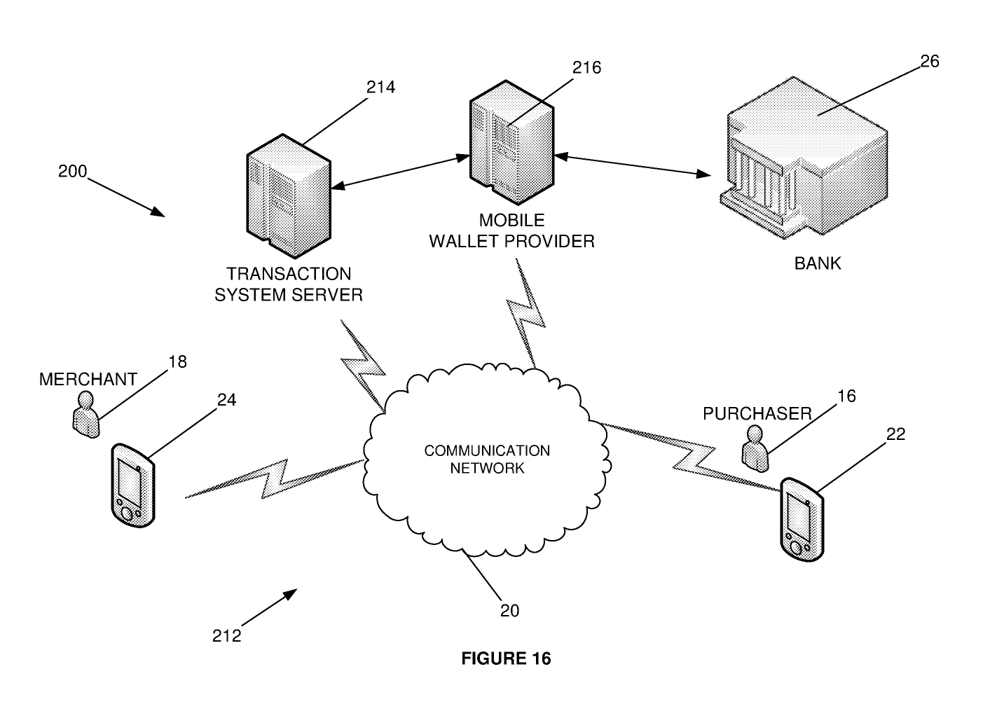

Referring to FIG. 16 of the drawings, another example embodiment of a network comprising a system 200 in accordance with an example embodiment is generally indicated by reference numeral 212. The system 200 is substantially similar to the system 10 described above and thus similar components will be indicated by the same reference numerals.

In general, the system 200 differs from the system 10 in that it instead of storing financial data such as bank account details, etc. associated with the purchaser 16 and processing payment and/or authorisations, the system 200, particularly a transaction system server 214 thereof, is configured to be in communicatively coupled with a mobile wallet provider 216 which facilitates the same. The mobile wallet provider 216 may be a conventional mobile wallet service provider 216 which comprises a database which stores credit card payment data securely and has capacity to process payments for the purchase of goods and/or services and/or authorisations. Though only one provider 216 is illustrated, the server 214 may be configured to be communicatively coupled to a plurality of providers 216.

It will be appreciated that in one example embodiment the mobile wallet provider 96 already has users in the form of users 16 and/or merchants 18 registered thereto and stores user profiles associated therewith in an associated database. If thus follows that the transaction system server 214 serves to extend the service offered by conventional mobile wallet providers 216 with the verbal payment methodology as aforementioned. In particular, the server 214 will thus provide a central, cloud-based processing interface between a purchaser 16 and a merchant 18 and will leave the storage of the card information and processing of the payment to the mobile wallet provider 216.

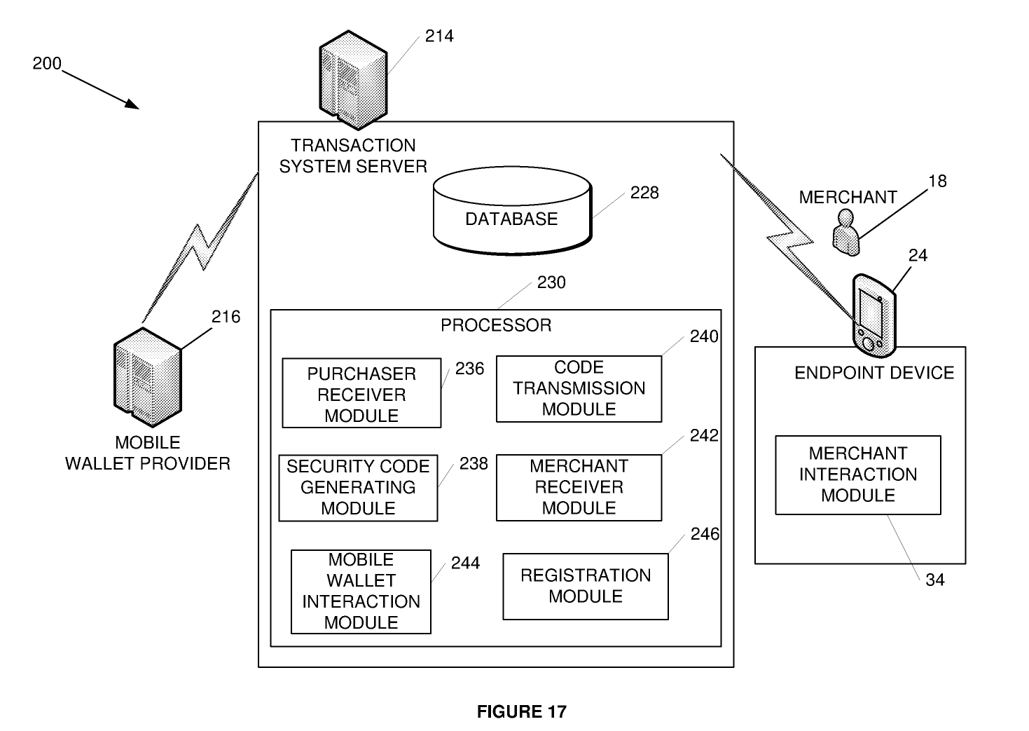

To this end, referring to FIG. 17 of the drawings, it will be appreciated that in the example embodiment system 200, the server 214 does not comprise a payment processing module of the type in the system of FIG. 10 but comprises a suitable mobile wallet provider interaction module 244. The mobile wallet provider interaction module 244 may be configured to allow the server 214 to interact with the mobile wallet providers 216. In particular, the mobile wallet provider interaction module 244 may be configured to receive transaction data associated with transactions to be processed via the providers 216 and pass on acceptance of a transaction from a merchant to the mobile wallet provider 216 for processing in a conventional fashion as will be described below. To this end, the server 214 may supply the providers 216 with two sets of interfaces, one for an associated software application provided by the providers 216 to the purchasers and one for interfaces with merchants.

Though not illustrated, the applications used by purchasers may be communicatively coupled directly to the server 214 or indirectly to the server via the providers 216 as described below.

On the merchant side, the server 214 may be communicatively coupled directly or indirectly to the merchants. For example, the module 34 may be a ready to use software application which is operable to directly communicate with the server 214. Instead, or in addition, the providers 216 may have associated applications which enable the merchants to communicate with the server 214 via the software applications associated with the providers 216.

The purchaser receiver module 236 of the server 214 is substantially similar to the one described above albeit the transaction data is not received directly from the purchaser 16 but indirectly from a software application module associated with the provider 216 which the purchaser 16 interacts with. In particular, the transaction data is received from the provider application via module 244 which sends the same to the module 236.

The security code generating module 238 may be substantially similar to the module 38 as described above. The code transmission module 240 on the other hand differs from the module 40 in that it is configured to transmit the generated code to the mobile wallet provider 216, for example, via the module 244. The provider 216 then provides the code to the purchaser by way of the associated software application module which the purchaser interacts with.

The registration module 246 may be substantially similar to the registration module 46 as described above, though it will be appreciated that in the present example embodiment there is no requirement for the purchaser 16 to register to the system 200. In some example embodiments, the merchant 18 may register.

The merchant receiver module 242 may, instead or in addition to the functionality of the similar module 42 as described above, be configured to transmit acceptance of a particular transaction through to the mobile wallet provider 216 which then would process payment accordingly. The server 214 may be configured to transmit contact information associated with the purchaser as received from the transaction data securely to the merchant interaction module 34. The extent of the information sent may depend on the merchant's requirements. In one example embodiment, the mobile wallet provider 216, particularly a purchaser application associated therewith may allow a purchaser to specify whether their contact information may be used for subsequent marketing purposes or not so as to protect the privacy of the purchaser, and to protect them from receiving unwanted spam. It will be appreciated that the module 34 may be associated with the server 214 and/or may be associated with the provider 216.

In addition, acceptance of the merchant's terms and conditions, as described above, may also be receivable by the transaction system server 214 and may transmit the acceptance to the mobile wallet provider 216. The system server 214 is also configured to, in response to the merchant 18 accepting payment, push a confirmation massage to the purchaser 16.

In use, referring to FIGS. 16 and 17, the purchaser 16 desiring to make a verbal payment in an associated software application of the mobile wallet provider 216 makes the appropriate selection. In the mobile wallet provider application, the purchaser 16 selects payment method and selects any information required, a CVV code, currency, and an amount of the transaction. As described above, the purchaser may make a selection of the information they wish to share with the merchant, for example, contact information.

The mobile wallet provider application will then establish a communication link with the transaction system server 214 and transmit transaction data comprising at least user identification, user name, the amount of the transaction, currency and any other information required. The transaction server purchaser receiver module 236 receives this information via the module 244. The module 236 may store the transaction data in the database 228, particularly, a PCI compliant data vault, only for a pre-determined period of time, for example, for the duration of the timed security code.

In response to receiving the transaction data, the transaction system server 214 may generate a security code and transmit the same to the mobile wallet provider 216 for presentation to the purchaser 16 via its associated application. The modules 238 and 240 typically undertake this step. It will be appreciated that the security code transmitted to the mobile wallet provider is configured to be displayed for a predetermined period as described above with respect to system. The purchaser 16 then verbally provides this code to the merchant 18 in the fashion as described above.

The merchant 18 then enters a received security code, which they receive verbally, into their associated mobile wallet provider merchant application or merchant interaction module 34. The code is received from the merchant 18 by the server 214, particularly, by module 242 in a similar fashion as described above in system 10. The associated determination of the validity of the code is also substantially similar as hereinbefore described.

It will be appreciated that the mobile wallet provider merchant application or module 34 retrieves payment details including the user name and contact information from the server 214 or provider 216. The merchant 18 is able to select applicable terms and conditions and accept the payment, wherein said acceptance of the payment is transmitted or received by the transaction system server 214 merchant receiver module 242. The system server 214 is then configured to push a confirmation message to the purchaser 16.

Once the merchant 18 has accepted the payment, the mobile wallet purchaser application will receive a push notification to identify the merchant 18 and await final confirmation from the purchaser 16. This may be done via the system server 214 or directly via the mobile wallet provider merchant application. It will be appreciated that the acceptance/rejection is preferably received by the server 214 which is operable to pass the same on to the provider 216. Once the purchaser 16 confirms the payment and accepts the merchant's terms and conditions, i.e., the final confirmation, the wallet provider 216 will proceed to execute payment in a conventional fashion.

If the transaction is successful said confirmation of the successful transaction is transmitted to the system server 214 which notifies the purchaser 16 and merchant 18 accordingly. If the payment or authorisation has failed the mobile wallet provider application will notify the system server 214 which then will provide an associated reason for failure of the transaction to the merchant 18 and purchaser 16.

Once the mobile wallet provider 216 has processed payment or authorisation, the, merchant 18 will receive a push notification or web-call back. It will be appreciated that if successful, the merchant 18 will receive authorisation information along with customer contact information. In addition, it will be appreciated that once payment is successful the system serve 214 is configured to share the contact information of the purchaser 16 and merchant 18 with each other respectively.

In one example embodiment, once the transaction is done or the timed security code has expired, some of the transaction data stored in the database 228 associated with the transaction is deleted, particularly purchaser contact information. The data retained is comprised of one or more of merchant details, date and time of the transaction, a mobile wallet provider transaction identifier, the transaction amount, status of the transaction, Purchaser name, and any other transaction reference for billing purposes.

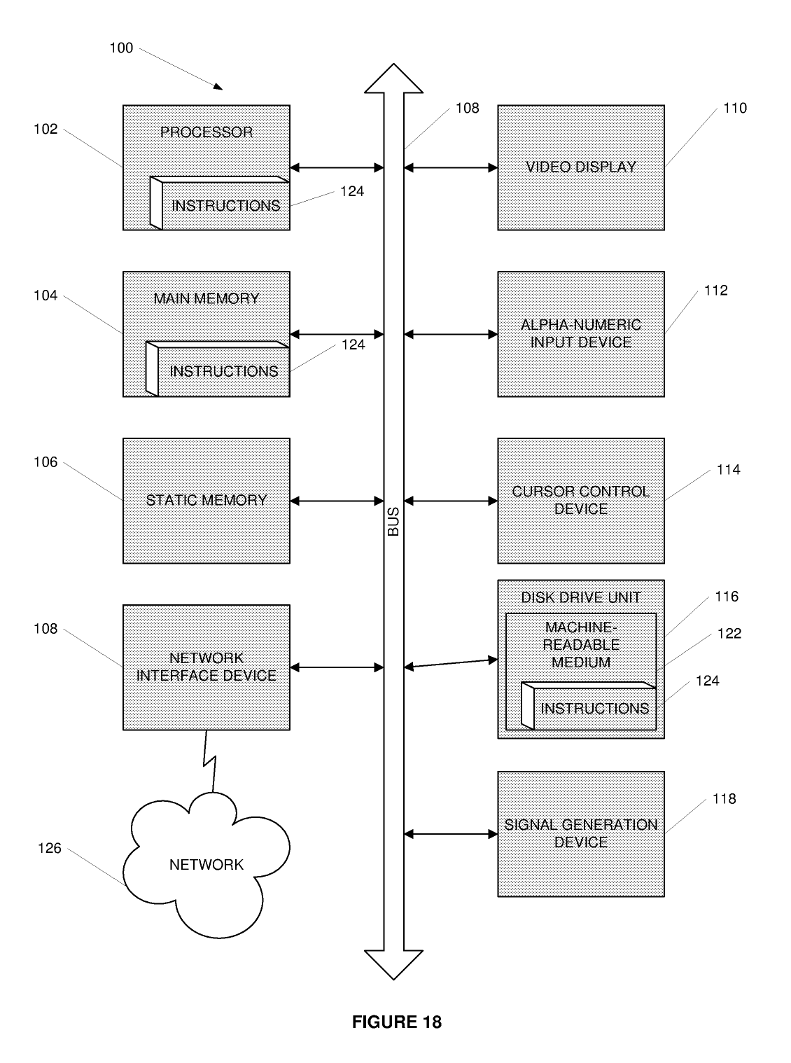

FIG. 18 shows a diagrammatic representation of machine in the example of a computer system 100 within which a set of instructions, for causing the machine to perform any one or more of the methodologies discussed herein, may be executed. In other example embodiments, the machine operates as a standalone device or may be connected (e.g., networked) to other machines. In a networked example embodiment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated for convenience, the term “machine” shall also be taken to include any collection of machines, including virtual machines, that individually or jointly execute a set (or multiple sets) of instructions to perform any one or more of the methodologies discussed herein.

In any event, the example computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse, or touchpad), a disk drive unit 116, a signal generation device 118 (e.g., a speaker) and a network interface device 120.

The disk drive unit 16 includes a machine-readable medium 122 storing one or more sets of instructions and data structures (e.g., software 124) embodying or utilised by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilising any one of a number of well-known transfer protocols (e.g., HTTP).

Although the machine-readable medium 122 is shown in an example embodiment to be a single medium, the term “machine-readable medium” may refer to a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilised by or associated with such a set of instructions. The term “machine-readable medium” may accordingly be taken to include, but not be limited to, solid-state memories, optical and magnetic media, and carrier wave signals.

The invention as described herein provides a secure way of facilitating a financial transaction between a purchaser and a merchant, particularly a transaction which occurs in real-time and requires the payment of a deposit or authorization of an amount almost instantaneously, for example, during a telephonic booking process, etc. In light of the invention as described herein, account information need not be shared with a merchant, in particular, a purchaser may select the contact information which they would like to share with the merchant. It will be noted that as the code is transmitted verbally from purchaser to merchant, and that due to the verbal nature of transaction, the agreement regarding the terms and conditions provides an immutable recording thereof.

1. A financial transaction system comprising:
a database configured to store data in a secure fashion; and
one or more processors comprising:
a purchaser receiver module configured to:
receive transaction data associated with a transaction for one or both of payment and authorization of a financial amount from a purchaser to a merchant, wherein received transaction data comprises information selected from a group comprising identifier information associated with the purchaser, a financial amount associated with the transaction, financial currency associated with the transaction, and a transaction identifier identifying the transaction;
a security code generating module configured to generate a timed security code, valid for a pre-determined period of time, in response to receiving transaction data, wherein the generated timed security code is linked to an associated transaction;
a code transmission module operable to transmit a generated security code for use by a purchaser wherein, in use, the security code is presented to a merchant by the purchaser in order to process a transaction associated with the security code; and
a merchant receiver module configured to:
receive a security code transmitted by a merchant at a merchant endpoint device, wherein the security code transmitted by the merchant is received thereby from a purchaser in respect of a transaction; and
determine whether the security code received is valid, or not thereby to facilitate the transaction.

2. A financial transaction system as claimed in claim 1, wherein the security code received by the merchant receiver module is a human-readable code presented verbally by the purchaser and is input to the merchant endpoint device.

3. A financial transaction system as claimed in claim 1, wherein the security code is selected from a group comprising a numeric code, an alpha-numeric code, a character-based code, and an image.

4. A financial transaction system as claimed in claim 1, wherein the merchant receiver module is configured to compare a received security code with a security code stored in the database, and determine if the same is valid upon a suitable match.

5. A financial transaction system as claimed in claim 1, wherein:
the database is configured to store data comprising a plurality of user profiles associated with one or both of purchasers and merchants, wherein the user profiles stores account data associated with one or more external financial accounts associated with the purchasers and users as well as personal data associated therewith;
the purchaser receiver module is configured to:
receive transaction data from a purchaser having a user profile stored in the database, wherein the received transaction data comprises information indicative of the financial account from which the purchaser desires to one or both of pay and authorize the financial amount; and
associate the received transaction data with the user profile of the associated purchaser in the database;
the security code generating module is configured to:
generate a timed security code in response to receiving transaction data from a purchaser; and
associate the generated timed security code with at least a user profile of the purchaser in the database;
the code transmission module is configured to transmit a generated timed security code to an endpoint device associated with a purchaser; and
the merchant receiver module is configured to:
receive a security code from a merchant having a user profile stored in the database;
determine whether or not the received security code is valid,
identify a user profile of a purchaser associated with the received security code if the security code is valid;
retrieve at least some of the transaction data, and personal data associated with the identified user profile of the purchaser; and
and, wherein the financial transaction system comprises:
a payment processing module configured to:
generate and transmit a merchant acceptance message comprising all or some of the retrieved data associated with a user profile identified by the merchant retriever module including payment method detail stored securely in the database, to the endpoint device associated with the merchant, wherein the merchant acceptance message prompts the merchant for an acceptance response for the transaction;
generate and transmit a purchaser acceptance message to the endpoint device associated with the purchaser, wherein the purchaser acceptance message prompts the purchaser for an acceptance response for the transaction; and
in response to receiving acceptance responses from the merchant and the purchaser, processing the transaction.

6. A financial transaction system as claimed in claim 1, wherein the system comprises a registration module operable to register a user to the system by generating and storing in the database a user profile associated therewith in response to receiving personal data and payment account data associated with the user, wherein the users are one or both of purchasers and merchants.

7. A financial transaction system as claimed in claim 1, wherein the merchant receiver module is configured to receive a selection of merchant terms and conditions applicable to a transaction from a merchant, wherein the purchaser must accept the merchant terms and conditions for the transaction in order for the transaction to be processed.

8. A financial transaction system as claimed in claim 7, wherein the system is configured to provide the purchaser access to terms and conditions selected by the merchant for a transaction.

9. A financial transaction system as claimed in claim 1, wherein the merchant terms and conditions are selected from a group of terms and conditions on an ad hoc basis per transaction or are predetermined.

10. A financial transaction system as claimed in claim 1, wherein the system comprises a purchaser interaction module operable on the endpoint device associated with the purchaser; and a merchant interaction module operable on the endpoint device associated with the merchant, wherein the purchaser interaction module is configured to receive and transmit data between the one or more processors and the endpoint device associated with the purchaser, and wherein the merchant interaction module is configured to receive and transmit data between the one or more processors and the endpoint device associated with the merchant.

11. A financial transaction system as claimed in claim 10, wherein the security code is displayed via the purchaser interaction module for a predetermined period of time on the endpoint device associated with the purchaser.

12. A financial transaction system as claimed in claim 5, wherein the merchant acceptance message comprises at least some transaction data and personal data associated with the purchaser, and wherein the purchaser acceptance message comprises at least personal data associated with the purchaser.

13. A financial transaction system as claimed in claim 5, wherein the payment processing module is operable to communicate with a financial institution associated with an account of the purchaser to facilitate one or both of a payment or an authorization to an account associated with the merchant.

14. A financial transaction system as claimed in claim 1, wherein:
the purchase receiver module is configured to receive transaction data from a mobile wallet provider;
the security code generating module is configured to generate a security code in response to receiving transaction data from a mobile wallet provider;
the code transmission module is operable to transmit a generated security code to a mobile wallet provider for transmission to a purchaser; and
the merchant receiver module is operable, in response to determining that a received security code is valid, to transmit a suitable message to the mobile wallet provider to process the associated transaction.

15. A financial transaction system as claimed in claim 14, wherein the system comprises a payment processing module configured, in response to the merchant receiver module determining that a received security code is valid to:
generate and transmit a merchant acceptance message comprising all or some of the transaction data to an endpoint device associated with the merchant, wherein the merchant acceptance message prompts the merchant for an acceptance response for the transaction;
generate and transmit a purchaser acceptance message to the endpoint device associated with the purchaser, wherein the purchaser acceptance message prompts the purchaser for an acceptance response for the transaction; and
in response to receiving acceptance responses from the merchant and the purchaser, transmitting a message to the mobile wallet provider to process the transaction.

16. A method of operating a financial transaction system comprising:
maintaining a database storing data in a secure fashion;
receiving, via a purchaser receiver module, transaction data associated with a transaction for one or both of payment and authorization of a financial amount from a purchaser to a merchant, wherein received transaction data comprises information selected from a group comprising identifier information associated with the purchaser, a financial amount associated with the transaction, financial currency associated with the transaction, and a transaction identifier identifying the transaction;
generating, via a security code generating module, a timed security code, valid for a pre-determined period of time, in response to receiving the transaction data, wherein the generated timed security code is linked to the transaction;
transmitting, via a code transmission module, the generated security code for use by the purchaser wherein, in use, the security code is provided by the purchaser to a merchant in order to process a transaction associated with the security code;
receiving, via a merchant receiver module, the security code transmitted by the merchant at a merchant endpoint device, wherein the security code transmitted by the merchant is received thereby from the purchaser in respect of a transaction; and
determining, via the merchant receiver module, whether the security code received thereby is valid to facilitate processing the transaction.

17. A method as claimed in claim 16, wherein the security code received by the merchant receiver module is a human-readable code presented verbally by the purchaser and is input to the merchant endpoint device.

18. A method as claimed in claim 16, wherein the security code is selected from a group comprising a numeric code, an alpha-numeric code, a character-based code, and an image.

19. A method as claimed in claim 16, wherein the method comprises determining if the security code is valid by comparing the received code with one or more codes stored in the database so as to determine a match.

20. A method as claimed in claim 16, wherein the database is configured to store data comprising a plurality of user profiles associated with one or both of purchasers and merchants, wherein the user profiles stores account data associated with one or more external financial accounts associated with the purchasers and merchants as well as personal data associated therewith, and wherein the method further comprises:
receiving transaction data from the purchaser having a user profile stored in the database, wherein the received transaction data comprises information indicative of the financial account from which the purchaser desires to one or both of pay and authorize the financial amount;
associating the received transaction data with a user profile of the purchaser stored in the database;
generating the timed security code in response to receiving transaction data from the purchaser;
associating the generated timed security code with at least the user profile of the purchaser in the database;
transmitting the generated timed security code to an endpoint device associated with the purchaser; and
receiving a security code from a merchant having a user profile stored in the database;
determining whether or not the received security code is valid,
identifying a user profile of a purchaser associated with the received security code if the security code is valid;
retrieving at least some of the transaction data, and personal data associated with the identified user profile of the purchaser;
generating and transmitting a merchant acceptance message, comprising all or some of the retrieved data associated with the identified user profile, to the endpoint device associated with the merchant, wherein the merchant acceptance message prompts the merchant for an acceptance response for the transaction on specific terms and conditions;
generating and transmitting a purchaser acceptance message to the endpoint device associated with the purchaser, wherein the purchaser acceptance message prompts the purchaser for an acceptance response for the transaction; and
in response to receiving acceptance responses from the merchant and the purchaser, processing the transaction.

21. A method a claimed in claim 16, wherein the method comprises registering a user to the system by generating and storing in the database a user profile associated therewith in response to receiving personal data and payment account data associated with the user.

22. A method as claimed in claim 16, wherein the method comprises receiving a selection of merchant terms and conditions applicable to a transaction from a merchant, and wherein the method comprises receiving acceptance of the merchant terms and conditions from the purchaser for the transaction in order for the transaction to be processed.

23. A method as claimed in claim 22, wherein the method comprises providing the purchaser with access to terms and conditions selected by the merchant for a transaction.

24. A method as claimed in claim 22, wherein the merchant terms and conditions are selected from a group of terms and conditions on one or both of an ad hoc basis per transaction and are predetermined per transaction.

25. A method as claimed in claim 16, wherein the method comprises displaying the security code for a predetermined period of time on an endpoint device associated with the purchaser.

26. A method as claimed in claim 16, wherein the method comprises:
receiving transaction data from a mobile wallet provider;
generating the security code in response to receiving transaction data from a mobile wallet provider;
transmitting the generated security code to the mobile wallet provider for transmission to a purchaser; and
in response to determining that a received security code is valid, transmitting a suitable message to the mobile wallet provider to process the associated transaction.

27. A method as claimed in claim 26, wherein the method comprises, in response to the merchant receiver module determining that a received security code is valid, the steps of:
generating and transmitting a merchant acceptance message comprising all or some of the transaction data to an endpoint device associated with the merchant, wherein the merchant acceptance message prompts the merchant for an acceptance response for the transaction;
generating and transmitting a purchaser acceptance message to the endpoint device associated with the purchaser, wherein the purchaser acceptance message prompts the purchaser for an acceptance response for the transaction; and
in response to receiving acceptance responses from the merchant and the purchaser, transmitting a message to the mobile wallet provider to process the transaction.

28. A non-transitory computer readable medium storing a set of computer executable instructions which when executed by one or more processors cause the same to:
maintain a database storing data in a secure fashion;
receive transaction data associated with a transaction for one or both of payment and authorization of a financial amount from a purchaser to a merchant, wherein received transaction data comprises information selected from a group comprising identifier information associated with the purchaser, a financial amount associated with the transaction, financial currency associated with the transaction, and a transaction identifier identifying the transaction;
generate a timed security code, valid for a pre-determined period of time, in response to receiving the transaction data, wherein the generated timed security code is linked to the transaction;
transmit the generated security code for use by the purchaser wherein, in use, the security code is provided by the purchaser to a merchant in order to process a transaction associated with the security code;
receive the security code transmitted by the merchant at a merchant endpoint device, wherein the security code transmitted by the merchant is received thereby from the purchaser in respect of a transaction; and
determine whether the security code received thereby is valid, or not, so as to allow or deny the associated transaction.
